(19) United States
(12) Patent Application Publication
(10) Pub. No.: US 2013/0060870 A1
(43) Pub. Date: Mar. 7, 2013

(54) METHOD AND SYSTEM FOR CREATING AND DELIVERING PERSONALIZED MESSAGES

(71) Applicants: Chris Albert Webb, Louisville, KY (US); James Yelich, Brentwood, TN (US); Richard C. King, JR., Glenview, KY (US)

(72) Inventors: Chris Albert Webb, Louisville, KY (US); James Yelich, Brentwood, TN (US); Richard C. King, JR., Glenview, KY (US)

(73) Assignee: 10ACIOUS, INC., Louisville, KY (US)

(21) Appl. No.: 13/469,453

(22) Filed: May 11, 2012

Related U.S. Application Data
(63) Continuation of application No. 12/557,808, filed on Sep. 11, 2009, now abandoned.
(60) Provisional application No. 61/096,842, filed on Sep. 14, 2008.

(51) Int. Cl. G06F 15/16

(52) U.S. Cl. 709/206

(57) ABSTRACT

A method for creating and delivering a personalized message, comprises the steps of: receiving, via an Internet web site, data from a client, including a selection of a celebrity and contact information for an intended recipient of the message; storing the data in a database; retrieving a message script from a database based on the selected celebrity; prompting the client to enter certain personal information about the intended recipient of the message; receiving the personal information about the intended recipient of the message; creating the personalized message from the message script and the personal information; and delivering the personalized message to the intended recipient using the contact information.

### CROSS-REFERENCE TO RELATED APPLICATIONS

The present application is a continuation of U.S. patent application Ser. No. 12/557,808 filed on Sep. 11, 2009, which claims priority to U.S. Provisional Patent Application Ser. No. 61/096,842 filed on Sep. 14, 2008.

### SUMMARY OF THE INVENTION

The present invention is a method and system for creating and delivering personalized messages.

Clients visit a web site and select the celebrity they would like to send their friend a message. They are then transported to another web portal where they can customize the script of what that celebrity will say through a series of drop-down boxes that have been pre-recorded. These drop-down boxes include names, favorite foods, TV shows, music genres, and special occasions. Once the script has been customized to the client's liking, they are given the opportunity to hear a preview of the message that the celebrity will send to their friend. After approval, this message will then be transcoded into a special format and either sent directly to their friend's mobile phone through a specialized IVR (Integrated Voice Response) system that will play the message only when their friend answers the phone. (The system is designed that if a voice mailbox system is detected, it will wait until it hears the beep and it will leave the customized message in the friend's mailbox.) The message is sent using provisioned caller identification so the celebrity name will appear on the handset when the call is being placed or send a link via an HTML email that will contain a link to the customized message.

### DESCRIPTION OF THE DRAWINGS

FIG. 1 is a schematic block diagram explaining the function of an exemplary system in accordance with the present invention;

FIG. 2 is a schematic block diagram explaining how the components of the exemplary system of FIG. 1 work together; and

FIG. 3 is a screen shot from the exemplary system of FIG. 1.

### DETAILED DESCRIPTION OF THE INVENTION

The present invention is a method and system for creating and delivering personalized messages.

The method and system is comprised of the following components: professionally recorded and edited scripts; web site with flash and e-commerce capabilities; mySQL database; mp3 file compiler; mp3 to wave transcoder; custom API integration tool; and IVR phone system with voice detection software.

Professionally recorded and edited scripts are stored in a mySQL database which populates the drop-down menus on the web site. After client has selected the drop-downs that they would like to send, the mp3 compiler pulls from the database the original script files along with the drop-down files that the client selected and compiles them into one message. That message is then available to be previewed by the client. Upon approval by the client, the client will then be taken to the e-commerce portion of the web site to actually pay for the service and fill out the scheduler information to send the message. After system receives payment, message is then delivered at the date, time, and choice of client. If client selected phone message, the customized message is then transcoded from an mp3 file to a wave file in the CCITT u-Law format. Once converted, it is then sent electronically via a special API tool to our IVR system which places the call and determines if there is a human voice. If a human voice is detected using the voice detection software, then the message is played. If a voicemail system is detected, then the voice detection software waits for the beep to leave the message. If the client chooses to deliver the message via email, the website uses JavaScript to create a custom HTML email, which it sends to the friend with a link to another custom HTML page which contains the compiled customized mp3 file. The customized message can be sent either through our custom IVR system directly to a phone number or via email where they are given a link to their customized message. When we transcode the client's customized script, we take those pre-recorded files which are stored in MP3 format, compile them, and convert the compiled file into a specialized format (CCITT u-Law file format) which is specifically formatted for the maximum quality and frequency to be transmitted over the phone system and then delivered to our IVR system. Our IVR system actually facilitates the phone call. As the call is made, it uses the voice detection software to detect when the friend answers the phone. If no human voice is detected, then IVR system determines if a voicemail system is in place. If a voicemail system is detected then, it then waits for the beep and plays the customized message in the CCITT u-Law format and then hangs up the phone. There is a provisioned caller identification feature that places the celebrities name on the handset when the call in being placed if no human voice answers, and there is no voicemail system in place, the IVR system will reschedule another time to attempt the call within 30 minutes. There is a maximum of 3 tries to attempt the call before the customized is sent via HTML email to the friend.

The customized message can be scheduled up to 1 (one) year in advance and still be delivered via both as a phone call and email. We can also use this system as an activity reminder system. Uses are similar to greeting cards and e-cards in which they provide inspiration and uplifting messages along with the entertainment factor of having their favorite celebrities deliver those messages. Personalized to the consumers liking, addresses the consumer by their first name.

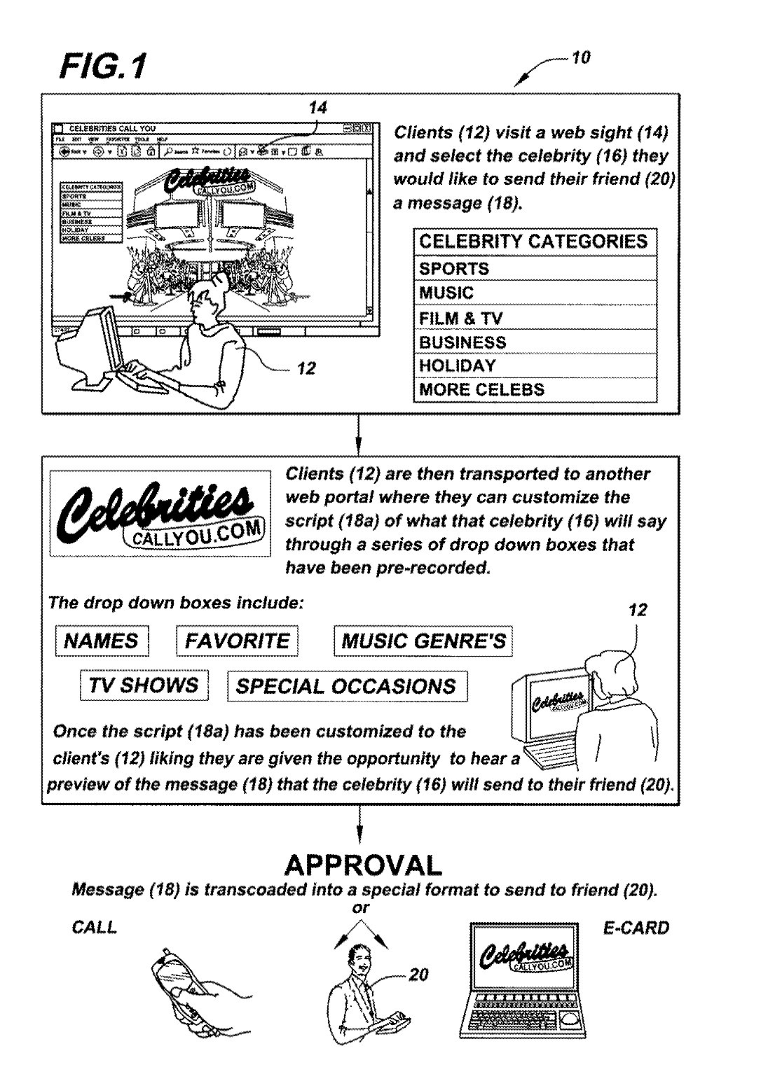

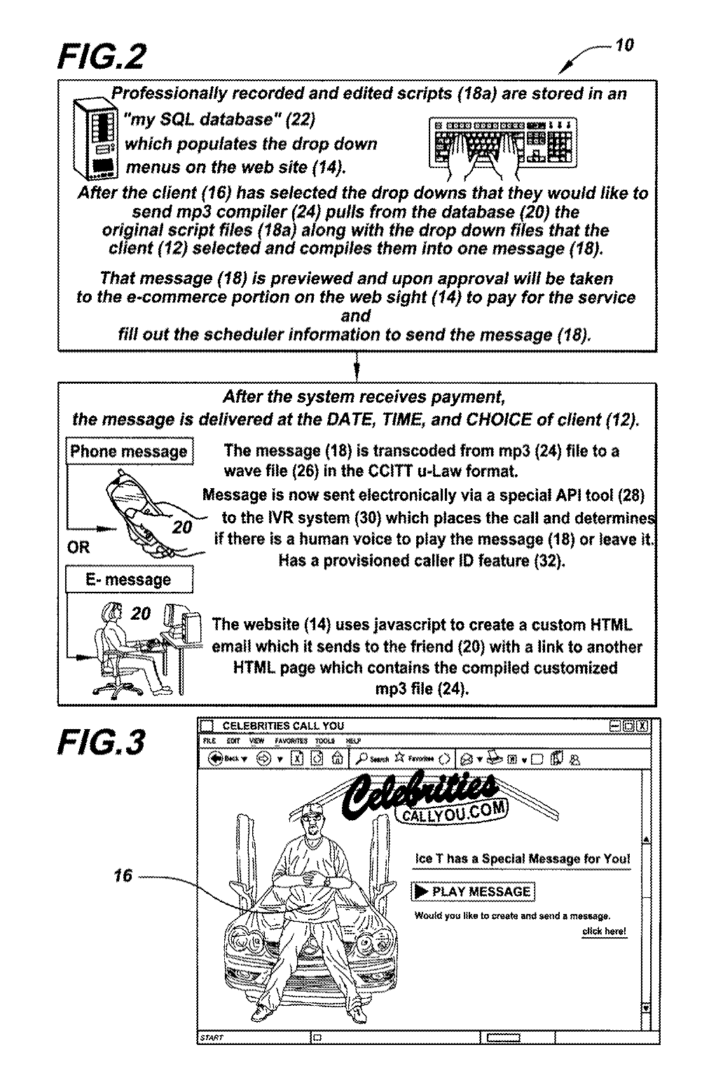

In FIGS. 1-3:

Reference number 10 refers to the overall system;

Reference number 12 refers to the client;

Reference number 14 refers to the web site;

Reference number 16 refers to any celebrity;

Reference number 18 refers to the finished edited message customized by client 12;

Reference number 18a refers to the professionally recorded original scripts;

Reference number 20 refers to the friend who will receive the message 18;

Reference number 22 refers to the “mySQL” database;

Reference number 24 refers to the mp3 file compiler;

Reference number 26 refers to the mp3 to wave transcoder;

Reference number 28 refers to the custom API integration tool;

Reference number 30 refers to the IVR phone system with voice detection software; and

Reference number 32 refers to the provisioned caller identification feature.

One of ordinary skill in the art will recognize that additional embodiments and implementations are also possible without departing from the teachings of the present invention or the scope of the claims which follow. This detailed description, and particularly the specific details of the exemplary embodiments and implementations disclosed, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A method for creating and delivering a personalized message, comprising the steps of:
receiving, via an Internet web site, data from a client, including a selection of a celebrity and contact information for an intended recipient of the message;
storing the data in a database;
retrieving a message script from a database based on the selected celebrity;
prompting the client to enter certain personal information about the intended recipient of the message;
receiving the personal information about the intended recipient of the message;
creating the personalized message from the message script and the personal information; and
delivering the personalized message to the intended recipient using the contact information.
